(19) United States
(12) Patent Application Publication
(10) Pub. No.: US 2013/0030987 A1
(43) Pub. Date: Jan. 31, 2013

(54) Paid Profile Personalization

(71) Applicants: Mark E. Zuckerberg, Palo Alto, CA (US); Prashant Chandra Fuloria, Los Altos, CA (US); Gokul Rajaram, Los Altos, CA (US)

(72) Inventors: Mark E. Zuckerberg, Palo Alto, CA (US); Prashant Chandra Fuloria, Los Altos, CA (US); Gokul Rajaram, Los Altos, CA (US)

(21) Appl. No.: 13/191,670

(22) Filed: Jul. 27, 2011

(51) Int. Cl. G06Q 40/02; G06Q 10/10

(52) U.S. Cl. 705/39

(57) ABSTRACT

In one embodiment, a system includes one or more computing systems that implement a social networking environment and are operable to provide paid profile personalization functions to users. In particular embodiments, the user may select one or more social networking objects to replace advertisements or other elements that are normally displayed to visitors of the user's profile page that are otherwise controlled by the social networking system. In particular embodiments, the user may edit elements on their profile page that are otherwise automatically generated and controlled in design and content by the social networking system. In particular embodiments, the user is billed on a recurring basis for profile personalization.

### TECHNICAL FIELD

The present disclosure relates generally to social networking, and more particularly, to a social networking system which allows profile personalization of otherwise pre-set profile attributes in exchange for a one-time, monthly, or recurring payment. The present disclosure additionally relates to processes for replacing profile elements that are commonly dictated by a social networking system with user-selected social networking objects.

### BACKGROUND

Computer users are able to access and share vast amounts of information through various local and wide area computer networks including proprietary networks as well as public networks such as the Internet. Typically, a web browser installed on a user's computing device facilitates access to and interaction with information located at various network servers identified by, for example, associated uniform resource locators (URLs). Conventional approaches to enable sharing of user-generated content include various information sharing technologies or platforms such as social networking websites. Such websites may include, be linked with, or provide a platform for applications enabling users to view “profile” pages created or customized by other users where visibility and interaction with such profiles by other users is governed by some characteristic set of rules. By way of example, a user profile may include such user-declared information as contact information, background information, job/career information, as well as interests.

A traditional social network is a social structure made of individuals, groups, entities, or organizations generally referred to as “nodes,” which are tied (connected) by one or more specific types of interdependency. Social network (graph) analysis views social relationships in terms of network theory consisting of nodes and edges. Nodes are the individual actors within the networks, and edges are the relationships between the actors. The resulting graph-based structures are often very complex. There can be many kinds of edges between nodes. In its simplest form, a social network, or social graph, is a map of all of the relevant edges between all the nodes being studied.

### BRIEF DESCRIPTION OF THE DRAWINGS

FIG. 1 illustrates an example computer network environment of an example social network environment.

FIG. 2 illustrates example components of an example social network environment.

FIG. 3 illustrates an example social graph.

FIGS. 4A-4B each illustrates an example user profile page.

FIG. 5 illustrates an example method of personalizing a user profile.

FIG. 6 illustrates an example personalized user profile.

FIG. 7 illustrates an example computer system architecture.

### DESCRIPTION OF EXAMPLE EMBODIMENTS

Particular embodiments relate to a social network environment that includes an infrastructure or platform (hereinafter infrastructure and platform may be used interchangeably) enabling an integrated social network environment. In the present disclosure, the social network environment may be described in terms of a social graph including social graph information. In particular embodiments, one or more computing systems of the social network environment implementing the social network environment include, store, or have access to a data structure that includes social graph information for use in implementing the social network environment described herein. In particular embodiments, the social graph information includes a first set of user nodes that each correspond to a respective user, and a second set of concept nodes that each correspond to a respective concept. As used herein, a “user” may be an individual (human user), an entity (e.g., an enterprise, business, or third party application), or a group (e.g., of individuals or entities) that interacts or communicates with or over such a social network environment. As used herein, a “concept” may refer to virtually anything that a user may declare or otherwise demonstrate an interest in, a like towards, or a relationship with, such as, by way of example, a sport, a sports team, a genre of music, a musical composer, a hobby, a business (enterprise), an entity, a group, a third party application, a celebrity, a person who is not a registered user, etc. In particular embodiments, each node has, represents, or is represented by, a corresponding web page (“profile page”) hosted or accessible in the social network environment. By way of example, a user node may have a corresponding user profile page in which the corresponding user can add content, make declarations, and otherwise express him or herself, while a concept node may have a corresponding concept profile page (“hub”) in which a plurality of users can add content, make declarations, and express themselves, particularly in relation to the concept. In particular embodiments, the social graph information further includes a plurality of edges that each define or represent a connection between a corresponding pair of nodes in the social graph.

In some embodiments, each edge may be one of a plurality of edge types based at least in part on the types of nodes that the edge connects in the social graph. By way of example, in one particular embodiment, each edge from a first edge type defines a connection between a pair of user nodes from the first set, while each edge from a second edge type defines a connection between a user node from the first set and a concept node from the second set. Furthermore, each edge from a third edge type may define a connection between a pair of concept nodes from the second set. In such embodiments, the edge itself may store, or be stored with, data that defines a type of connection between the pair of nodes the edge connects, such as, for example, data describing the types of the nodes the edge connects (e.g., user or concept), access privileges of an administrator of one of the pair of nodes connected by the edge with respect to the other node the edge connects to (e.g., read or write access of an administrator of one node with respect to the other node connected by the edge), or data describing how or why the edge was first initialized or created (e.g., in response to an explicit user action or declaration, or automatically without an explicit user action), the strength of the connection as determined by various factors or criteria related to or shared by the nodes connected by the edge, among other suitable or relevant data. In an alternate embodiment, each edge may simply define or represent a connection between nodes regardless of the types of nodes the edge connects; that is, the edge itself may store, or be stored with, identifiers of the nodes the edge connects but may not store, or be stored with, data that describes a type of connection between the pair of nodes the edge connects. Furthermore, in any of these or other embodiments, data that may indicate the type of connection or relationship between nodes connected by an edge may be stored with the nodes themselves.

As described, in various example embodiments, one or more described web pages or web applications are associated with a social network environment or social networking service. As used herein, a “user” may be an individual (human user), an entity (e.g., an enterprise, business, or third party application), or a group (e.g., of individuals or entities) that interacts or communicates with or over such a social network environment. As used herein, a “registered user” refers to a user that has officially registered within the social network environment (Generally, the users and user nodes described herein refer to registered users only, although this is not necessarily a requirement in other embodiments; that is, in other embodiments, the users and user nodes described herein may refer to users that have not registered with the social network environment described herein). In particular embodiments, a registered user has a corresponding “profile” page stored or hosted by the social network environment and viewable by all or a selected subset of other users. Generally, a user has administrative rights to all or a portion of his or her own respective profile page; however, the social networking system itself may dictate various elements of all profile pages to maintain aesthetic and functional consistency. For example, the social networking system may dictate the overall layout of users' profile pages, including the placement of elements, the sizing of profile pictures, and the like. Additionally, the social networking system may reserve screen real estate for various social networking functions, such as an “events” area for alerting the user of upcoming birthdays, anniversaries, and events, a “suggestions area” for suggesting friends, businesses, movies, and the like to users, a “surveys” area for providing questions or polls to users, and an advertisement space for delivering paid ads or sponsored stories to the user.

As used herein, a “connection” may represent a defined relationship between users or concepts of the social network environment, which can be defined logically in a suitable data structure of the social network environment and can be used to define a relationship (hereinafter referred to as an edge) between the nodes corresponding to the users or concepts of the social network environment for which the connection has been made. As used herein, a “friendship” represents a connection, such as a defined social relationship, between a pair of users of the social network environment. A “friend,” as used herein, may refer to any user of the social network environment with which another user has formed a connection, friendship, association, or relationship with, causing an edge to be generated between the two users. By way of example, two registered users may become friends with one another explicitly such as, for example, by one of the two users selecting the other for friendship as a result of transmitting, or causing to be transmitted, a friendship request to the other user, who may then accept or deny the request. Alternately, friendships or other connections may be automatically established. Such a social friendship may be visible to other users, especially those who themselves are friends with one or both of the registered users. A friend of a registered user may also have increased access privileges to content, especially user-generated or declared content, on the registered user's profile or other page. It should be noted, however, that two users who have a friend connection established between them in the social graph may not necessarily be friends (in the conventional sense) in real life (outside the social networking environment). For example, in some implementations, a user may be a business or other non-human entity, and thus, incapable of being a friend with a human being user in the traditional sense of the word.

Particular embodiments may operate in, or in conjunction with, a wide area network environment, such as the Internet, including multiple network addressable systems.

FIG. 1 illustrates an example network environment, in which various example embodiments may operate. Network cloud 60 generally represents one or more interconnected networks, over which various systems and hosts described herein may communicate. Network cloud 60 may include packet-based wide area networks (such as the Internet), private networks, wireless networks, satellite networks, cellular networks, paging networks, and the like. As FIG. 1 illustrates, particular embodiments may operate in conjunction with a network environment comprising social network environment 20 and client devices 30, as well as, in some embodiments, one or more third party web application servers 40 or one or more enterprise servers 50. Client devices 30, web application servers 40, and enterprise servers 50 may be operably connected to the network environment and network cloud 60 via a network service provider, a wireless carrier, a set of routers or networking switches, or any other suitable means.

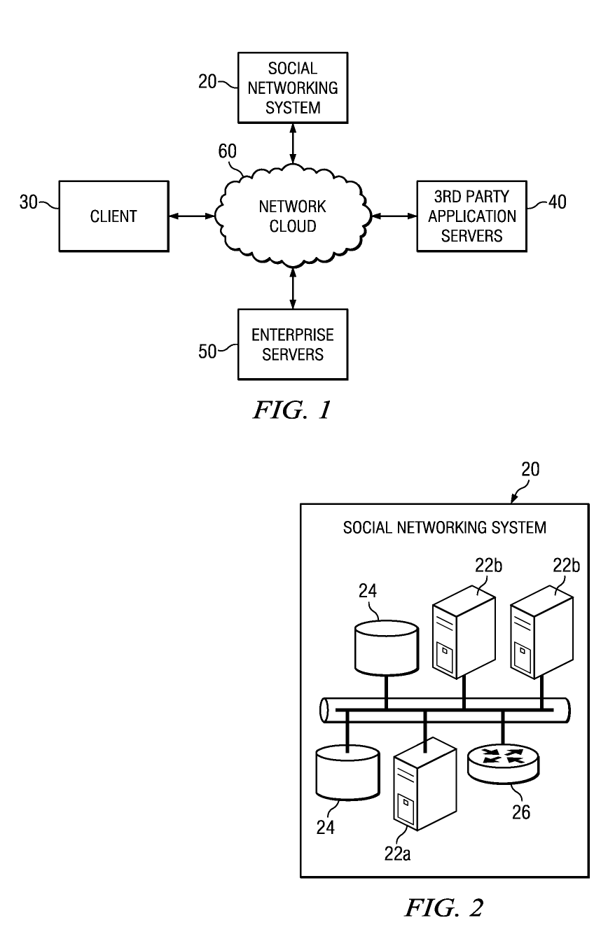

Each client device 30, web application server 40, or enterprise server 50 may generally be a computer, computing system, or computing device (such as that described below with reference to FIG. 9) including functionality for communicating (e.g., remotely) over a computer network. Client device 30 in particular may be a desktop computer, laptop computer, personal digital assistant (PDA), in- or out-of-car navigation system, smart phone or other cellular or mobile device, or mobile gaming device, among other suitable computing devices. Client device 30 may execute one or more client applications, such as a web browser 202 (e.g., MICROSOFT WINDOWS INTERNET EXPLORER, MOZILLA FIREFOX, APPLE SAFARI, GOOGLE CHROME, AND OPERA, etc.), as illustrated in FIG. 2B, to access and view content over a computer network 60. In particular implementations, the client applications allow a user of client device 30 to enter addresses of specific network resources to be retrieved, such as resources hosted by social network environment 20, web application servers 40, or enterprise servers 50. These addresses can be Uniform Resource Locators (URLs). In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page.

More particularly, when a user at a client device 30 desires to view a particular web page (hereinafter also referred to as a target structured document) hosted by social network environment 20, or a web application hosted by a web application server 40 and made available in conjunction with social network environment 20, the user's web browser 202, or other client-side structured document rendering engine or suitable client application, formulates and transmits a request to social network environment 20. The request generally includes a URL or other document identifier as well as metadata or other information. By way of example, the request may include information identifying the user, such as a user ID, as well as information identifying or characterizing the web browser 202 or operating system running on the user's client computing device 30. The request may also include location information identifying a geographic location of the user's client device or a logical network location of the user's client device, as well as timestamp identifying when the request was transmitted.

In an example implementation, when a request for a web page or structured document hosted by social network environment 20 is received by the social network environment 20, one or more page-generating processes 200 executing within the social network environment 20 typically generate a base web page in the form of a Hyper Text Markup Language (HTML), Extensible Markup Language (XML), or other web browser-supported structured document. The generated structured document is then transmitted in a response, which may comprise one or more portions or partial responses, to the requesting client 30 via a Hypertext Transfer Protocol (HTTP) or other suitable connection for rendering by the web browser 202 at the client device 30. The structured document may include one or more resources (e.g. JavaScript scripts, code segments, or resources, Cascading Style Sheet (CSS) code segments or resources, image data or resources, video data or resources, etc.), or references to such resources, embedded within the transmitted document. By way of example, a resource embedded in an HTML document may generally be included or specified within a script element, image element, or object element, among others, depending on the type of resource. The element referencing or specifying the resource may include a source attribute (e.g., src) identifying a location of the resource, which may be within a server or data store within social network environment 20 or at one or more external locations, to the client device 30 requesting the web page. Typically, upon receipt of the response, the web browser 202 or other client document rendering application running at the client device 30 then constructs a document object model (DOM) representation of the received structured document and requests the resource(s) (which may be at one or more other external locations) embedded in the document.

In an example implementation, when a registered user of social network environment 20 first requests a web page from social network environment 20 in a given user session, the response transmitted to the user's client device 30 from social network environment 20 may include a structured document generated by page-generating process 200 for rendering a login page at the client device. The user may then enter his or her user login credentials (e.g., user ID and password), which are then transmitted from the user's client device 30 to social network environment 20. Upon successful authentication of the user, social network environment 20 may then transmit a response to the user's web browser 202 at the user's client device 30 that includes a structured document generated by page-generating process 200 for rendering a user homepage or user profile page at the user's client device.

In one example embodiment, social network environment 20 comprises computing systems that allow users at client devices 30 to communicate or otherwise interact with each other and access content, such as user profiles, as described herein. Social network environment 20 is a network addressable system that, in various example embodiments, comprises one or more physical servers 22 or 22b (hereinafter also referred to collectively as servers 22) as well as one or more data stores collectively referred to herein as data store 24 (which may be implemented in or by one or more of a variety of consolidated or distributed computing systems, databases, or data servers), as illustrated in FIG. 2. The one or more physical servers 22 are operably connected to computer network 60 via, by way of example, a set of routers or networking switches 26. In an example embodiment, the functionality hosted by the one or more physical servers 22 may include web or HTTP servers, FTP servers, as well as, without limitation, web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), and the like.

Physical servers 22 may host functionality directed to the operations of social network environment 20. By way of example, social network environment 20 may host a website that allows one or more users, at one or more client devices 30, to view and post information, as well as communicate with one another via the website. Hereinafter, servers 22 may be referred to as server 22, although, as just described, server 22 may include numerous servers hosting, for example, social network environment 20, as well as other content distribution servers, data stores, or databases. Data store 24 may store content and data relating to, and enabling, operation of the social network environment as digital data objects including content objects. A data object, in a particular implementation, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 24 corresponds to one or more of a variety of separate or integrated databases, such as relational databases and object-oriented databases, that maintain information as an integrated collection of logically related records or files stored on one or more physical systems. Structurally, data store 24 may generally include one or more of a large class of data storage and management systems. In particular embodiments, data store 24 may be implemented by any suitable physical system(s) including components, such as one or more database servers, mass storage media, media library systems, storage area networks, data storage clouds, and the like. In one example embodiment, data store 24 includes one or more servers, databases (e.g., MySQL), and/or data warehouses.

Data store 24 may include data associated with different social network environment 20 users, client devices 30, web application servers 40, or enterprise servers 50, as well as, in particular embodiments, data associated with various concepts. As described above, particular embodiments relate to a social network environment 20 that includes a platform enabling an integrated social network environment. In the following example embodiments, the social network environment may be described or implemented in terms of a social graph including social graph information. In particular embodiments, data store 24 includes a social graph database 206 in which the social graph information for use in implementing the social network environment described herein is stored. In particular embodiments, the social graph information stored by social network environment 20 in data store 24, and particularly in social graph database 206, includes a plurality of nodes and a plurality of edges that define connections between corresponding nodes. In particular embodiments, the nodes or edges themselves are data objects that include the identifiers, attributes, and information (including the information for their corresponding profile pages) for their corresponding users or concepts (as described below), some of which is actually rendered on corresponding profile or other pages. The nodes may also include pointers or references to other objects, data structures, or resources for use in rendering content in conjunction with the rendering of the profile pages corresponding to the respective nodes.

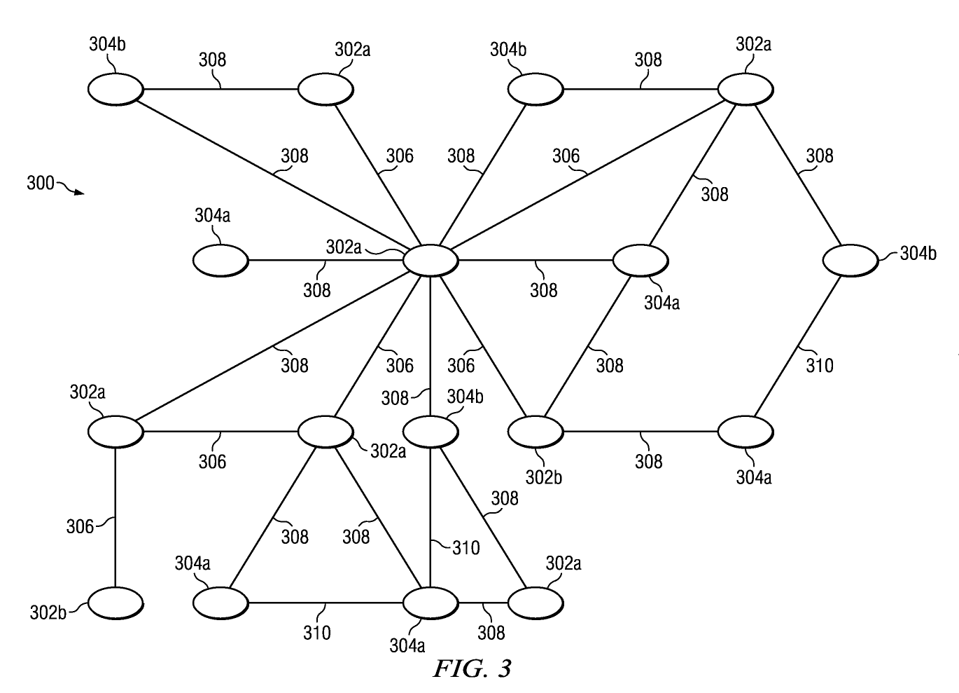

FIG. 3 illustrates an example social graph 300 shown, for didactic purposes, in a two-dimensional visual map representation. In particular embodiments, the plurality of nodes and edges of social graph 300 are stored as data objects in data store 24, and particularly social graph database 206, as described above. Additionally, as will be described later, data store 24 may further include one or more searchable or queryable indexes of nodes or edges generated by indexing social graph database 206. In particular embodiments, the plurality of nodes includes a first set of administered nodes 302 and a second set of un-administered nodes 304. In particular embodiments, the first set of administered nodes 302 are user-administered nodes (hereinafter also referred to as “user nodes”) that each correspond to a respective user and a respective user profile page of that user. In particular embodiments, user profile pages corresponding to user nodes 304 may be modified, written to, or otherwise administered by, and only by, their respective owner (registered) users (unless an official administrator of social network environment 20 in general desires or requires access to modify or delete a user's profile page, e.g., as a result of scrupulous or otherwise inappropriate action on the part of the registered user). In one particular embodiment, the first set of user nodes 302 includes a first subset of authenticated nodes 302a and a second subset of un-authenticated nodes 302b. In a particular embodiment, the first subset of authenticated nodes 302a correspond to respective registered authenticated users while the second subset of un-authenticated nodes 302b correspond to registered users who have not been authenticated by social network environment. For example, an authenticated user may be a user who has been verified to be who they claim to be in his or her respective profile page while an un-authenticated user may be a user who has not been verified to be who they claim to be in his or her respective profile page (e.g., an un-authenticated user may register a profile page in President Barack Obama's name, although the un-authenticated user is not President Obama). In some embodiments, for some existing user profile pages, social network environment 20 may determine whether the administrator of the user profile page is truly the authentic voice of the claimed user (real person the user claims to be). If it is determined that the current administrator is not the authentic or true claimed user, social network environment 20 may remove the user's administrative rights to the page. In this way, the user node and corresponding user profile page may be redefined in the social graph information stored in social graph database 206 as a concept node 304 and corresponding concept profile page as will be described later. It should further be noted that, in various example embodiments, user nodes 302a and 302b may or may not be classified distinctly as different node types; that is, in one embodiment, a user node 302 may be identified as an authenticated user node or an un-authenticated user node based on the data stored with or within the data object corresponding to the node rather than by an explicit user node type or sub-type.

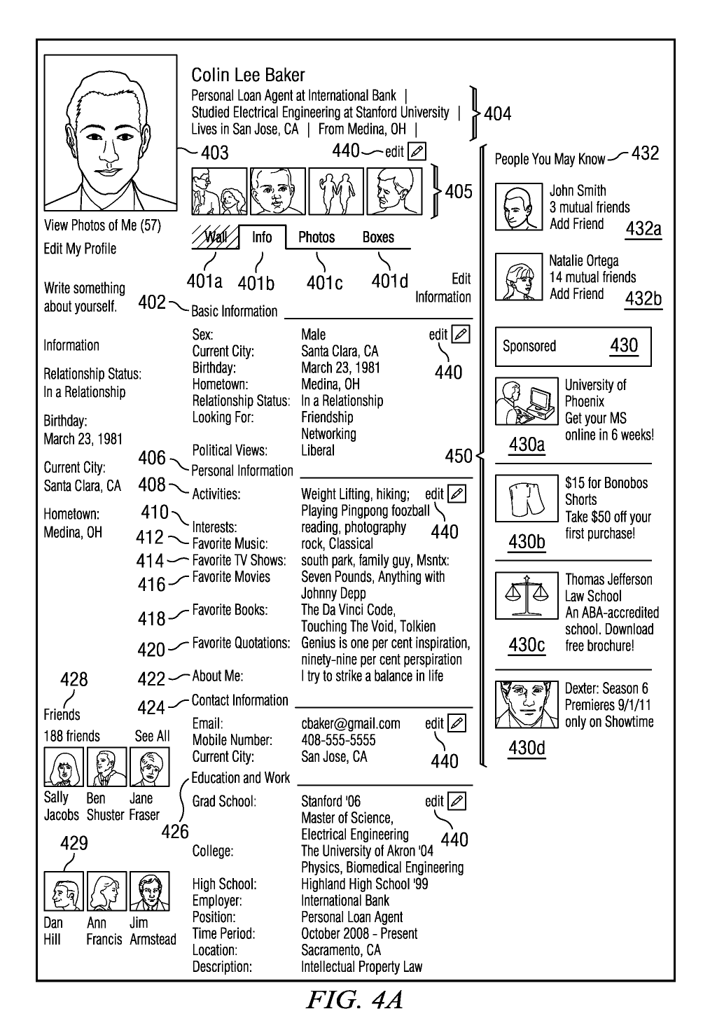

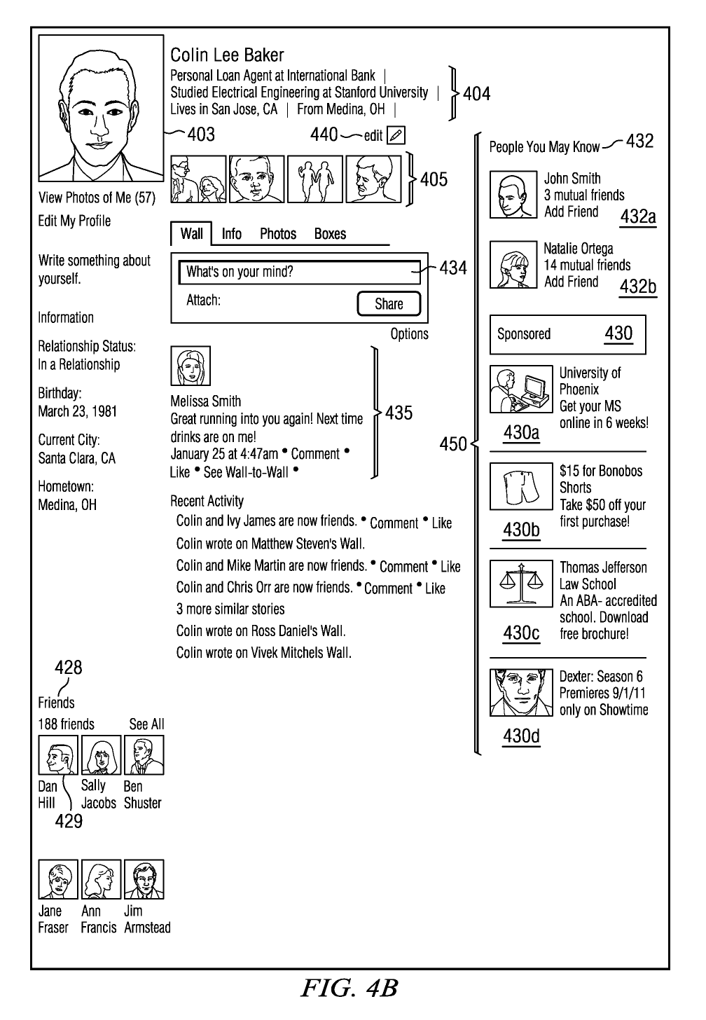

FIG. 4A illustrates an example user profile page 400 of a user corresponding to a user node 302. In particular embodiments, a user profile page is visible to the user, the user's friends, and even other non-friend users depending on privacy settings, which may be set or modified by the user via the user's profile page or a user homepage, for example. The user profile page may comprise a number of different subpages viewable or accessible via selecting one or more tabs 401. By way of example, in the embodiment illustrated in FIG. 4A, the user profile page includes a Wall (feed) tab 401a for accessing a wall (feed) for postings (described below), an Info tab 401b for entering and displaying information about or related to the user, a Photos tab 401c for uploading and displaying photos, and a Boxes tab 401d. A user may select a particular photo or picture uploaded in photos tab 401c for display as a user profile picture 403. In an example implementation, the user's profile picture 403 as well as other features such as, for example, the options to send a message to another user, edit the profile page, view friends of the user, or view photos of the user, may be displayed in a “chrome” (border) region of the page no matter which of tabs 401 is selected. In some implementations, a search bar or search interface is also rendered in the chrome of a user profile page (as well as other pages) enabling users to type in information such as names of other users or concepts the user desires to search for.

Profile page 400 may also include summary section 404, which includes a quick summary of the user's “vital information,” such a, in particular embodiments, the user's position and employer, major and educational institution, current city, and hometown. Summary section 404 may include any information included in profile 400. This disclosure contemplates any suitable arrangement and content of summary section 404 and profile page 400.

Profile page 400 may also include photo filmstrip 405, which displays thumbnail images of, in particular embodiments, the four most recently tagged photos of the user. In particular embodiments, photo filmstrip 405 may include any number of photos. In particular embodiments, photo filmstrip includes the most engaging photos, such as photos that have the greatest number of comments, “likes”, or views. In particular embodiments, photo filmstrip 405 includes videos. This disclosure contemplates any suitable arrangement and content of photo filmstrip 405.

Generally, a great portion of, or all of, the information accessible or visible to the user and other users via the user profile page is self-declared; that is, the user types or otherwise enters information or content in various sections or forms that may or may not automatically appear by default when the user profile page is created. In particular embodiments, a user may edit his or her user profile page at anytime the user is logged into social network environment 20. By way of example, user profiles include data that describe the respective users of the social network enabled by social network environment 20, which may include, for example, proper names (first, middle and last of a person, a trade name or company name of a business entity, etc.) biographic, demographic, and other types of descriptive information in a basic information section 402 under Info tab 401b. The basic information section 402 may further include a user's sex, current city of residence, birthday, hometown, relationship status, political views, what the user is looking for or how the user is using the social network (e.g., for looking for friendships, relationships, dating, networking, etc.), and the like.

In particular embodiments, a user profile page may also include a personal information section 406 where the user can enter more personal declarations. By way of example, a personal information section 406 may include a sub-section 408 in which the user may declare various activities he, she, or it participates in or enjoys such as, for example, sports or music. For example, in section 408, the user may declare these activities by, for example, simply listing the activities. For example, the user may list “weight lifting, hiking, playing pingpong, and foozball,” or may use phrases such as, for example, “I enjoy weightlifting, I like hiking, I love playing pingpong, I′m good at foozball.” The user may separate or delineate his or her declared activities with, for example, commas, semicolons, dashes, or carriage returns. An example personal information section 406 may also include a sub-section 410 in which the user may declare various interests. Again, the user may simply list such interests, such as by typing, for example, “reading and photography,” or by using phrases such as, for example, “I like to read, I like photography.” As another example, interests section 406 may include a favorite music sub-section 412 in which the user may declare music he or she likes or is interested in, a favorite TV shows sub-section 414, a favorite movies sub-section 416, a favorite books sub-section 418, a favorite quotations sub-section 420, and even a general “about me” sub-section 422 in which the user may enter general declarations about himself or herself that may not fit under the previously described sections.

In particular embodiments, a user profile page may also include a contact information section 424 in which the user may enter various contact information including, for example, email addresses, phone numbers, and city of residence. A user profile page may also include an education and work section 426 in which the user may enter his or her educational history. By way of example, a user may declare that he or she attended Stanford University in section 426 by, for example, simply typing “Stanford University,” by typing “I attended Stanford University,” or by selecting Stanford University from a menu interface. The user may also describe more specific information, such as, for example, the degree awarded, the field of the degree, the graduation date, etc. As another example, section 426 may enable the user to enter the user's work experience. By way of example, a user may declare that he or she works at company Z by, for example, simply typing “Company Z,” by typing “I work at Company Z,” or selecting company Z from a menu.

In particular embodiments, one or more terms in declarations entered in one or more of the previously described sections or sub-sections may be highlighted, rendered in a different color, underlined, or clickable. By way of example, one or more terms entered as declarations, and particularly terms matched to known concepts or existing concept nodes 304, may be associated with a hyperlink that, when clicked or otherwise selected, directs the user to a concept profile page devoted to the term and, in particular embodiments, having a name identical or similar to the declared term. By way of example, clicking on a hyperlink corresponding to “Family Guy” in favorite TV shows section 414 may direct the user to a web page (a concept profile page/hub as described below) devoted to the Family Guy TV show.

In particular embodiments, a user profile page also includes a friends section 428 (which may be visible in the chrome or other region of the page) that displays all or a subset of the user's friends as defined by edges in the social graph stored in social graph database 206. In particular embodiments, the user may click on a name or thumbnail image 429 associated with a friend resulting in the directing of the user to the user profile page of the selected friend. In particular embodiments, any action that a user takes with respect to another second user, whether or not the second user may be a friend of the user or not, and, in particular embodiments, actions that the user takes with respect to various concept nodes, may be displayed in a recent activity section 430, which may be viewable as a sub-section within a wall (feed) section 432 under Wall (feed) tab 401a. Generally, wall (feed) section 432 is a space on every user's profile page that allows the user and friends to post messages via input box 434 for the user and friends to see, as well as to comment or otherwise express themselves in relation to posts on the wall (feed).

In particular embodiments, independent of profile page 400, social networking system 20 may display banner ads, quizzes, recommendations, or other content in the right-hand side (RHS) 450 of a user's display. RHS 450 may include any manner of content to a user of the social networking system, and, in particular embodiments, is independent of whether a user is viewing user profile 400, his or her own user profile 400, a concept node profile page, his or her news feed, etc. RHS 450 is persistent and delivers personalized content to the viewing user of social networking system 20 through advertisements, recommendations, sponsored stories, quizzes, reminders, events, and the like. In particular embodiments, RHS 450 may be along the top, left, bottom, or any position of a viewing user's display. This disclosure does not constrain RHS 450 to any particular position in users' displays, and contemplates any placement of RHS 450.

In particular embodiments, RHS 450 may include a recommendations section 432 that includes recommendations for the viewing user for other users on the social networking system they may know, such as users 432a and 432b. Recommendations section 432 may also recommend concept nodes, such as movies, restaurants, music, and the like. This disclosure contemplates any type of recommendation for recommendation section 432.

RHS 450 may also include sponsored section 430. Sponsored section 430 may include advertisements 430a-430d. In particular embodiments, advertisements 430a-430d may take the format of a sponsored story, that is, a newsfeed story from their own newsfeed regarding a specific concept node that is promoted to RHS 450 by the administrator of the concept node. In particular embodiments, advertisements 430a-430d may be tailored to the viewing user through the use of an advertisement selection algorithm. In particular embodiments, advertisements 430a-430d may be a story or other content promoted by a particular friend of the viewing user. For example, a friend of the viewing user may wish to, for a fee, feature one or more photos as a persistent advertisement.

In particular embodiments, social networking system 20 maintains a high degree of control over the design, layout, and content of user profile 400 and RHS 450. For example, while the user may populate the fields of 402, and 406-426, in particular embodiments, the user may not choose to alter its appearance or visibility. Similarly, in particular embodiments, the owner of profile 400 may not choose whether to display photo filmstrip 405, or choose which photos social networking system 20 displays in photo filmstrip 405. In particular embodiments, social networking system 20 exercises complete control over RHS 450 for any particular user's display, regardless of what the user is viewing.

FIG. 4B depicts a user's display when viewing wall 401a of a particular user's profile 400 (in this case, “Colin Lee Baker”). As previously described with respect to FIG. 4A, profile 400 may include elements whose appearance and content are completely controlled by social networking system 20, for instance summary section 404, photo filmstrip 405, and RHS 450. In particular embodiments, RHS 450 is refreshed with new content 432 and 430 every time a user clicks one of tabs 401a-401d. In particular embodiments, any interaction with profile 400, such as typing a status message into status box 434 for generation of a newsfeed story or wall comment 435, results in refreshing of RHS 450. Regardless of the refresh rate or content of RHS 450, the owner of profile 400 has, in particular embodiments, little or no control over the content displayed in RHS 450 and other select profile elements.

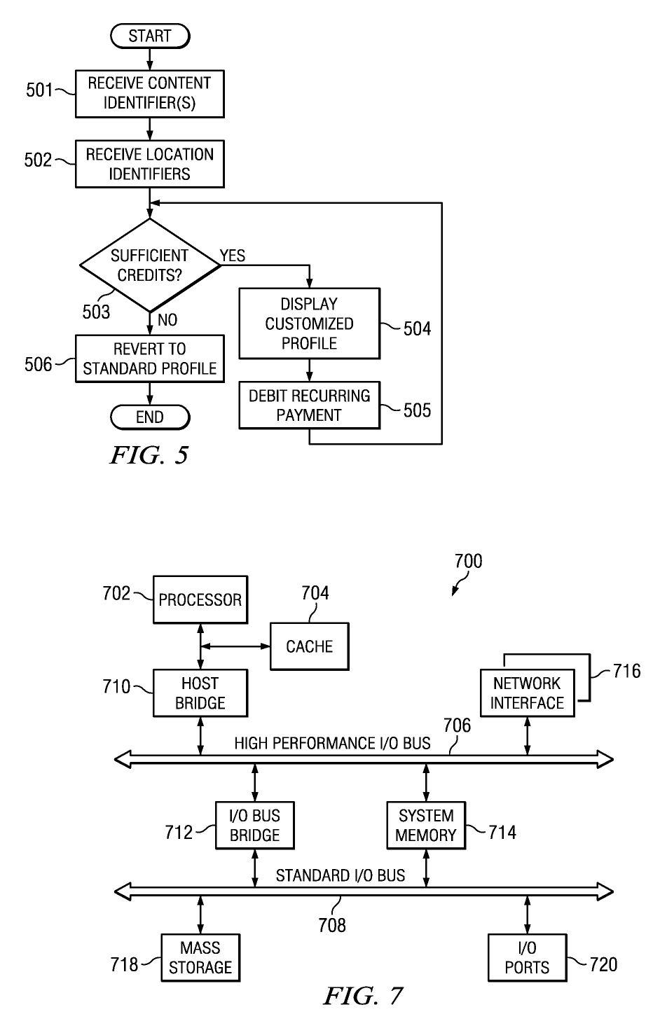

FIG. 5 is a flow diagram illustrating an example method permitting users to customize their own profile 400 in exchange for a one-time fee or recurring subscription. At Step 501, social networking system 20 receives one or more content identifiers from a particular user wishing to customize or personalize her or her own profile page 400. The content identifiers may uniquely identify any one or more social networking objects, such as photos, albums, videos, links, comments, notes, comment threads, shared media, or the like. For example, a user may wish to highlight a particular photo or particular photo album on his or her profile. This disclosure contemplates permitting a user to highlight or customize his or her own profile 400 with any type of social networking object.

At Step 502, the user enters one or more location identifiers for each social networking object to be displayed on his or her customized profile page; these location identifiers are utilized by social networking system 20 for building and rendering the customized profile. For example, the user may wish to replace the photos in photo filmstrip 405 to four or five photos of his or her own choosing. In particular embodiments, the user may replace content in all or a portion of RHS 450, such as recommendation section 432 or advertisement section 430. In particular embodiments, the user may adjust the ordering of friends section 428. In particular embodiments, the user may choose to edit, omit, or replace summary section 404. For example, a user may choose to replace summary section 404 with a quotation that he or she feels is a better indication of the user's personality or sense of identity. In particular embodiments, the user may pin a particular newsfeed story 435 to the top of his wall 401a. For example, the user may have a particular comment thread that he or she finds amusing or particularly flattering, and may wish to pin it to the top of his or her wall 401. In particular embodiments, any of the specified locations may be customized into a slideshow of rotating photos from a particular album or selected by the user. In particular embodiments, the slideshow may only change photos when a viewing user clicks the photo. In particular embodiments, the user may upload or create new content specifically for profile personalization. This disclosure contemplates any suitable location for the display of content in a personalized profile.

At Step 503, the user's account is queried to determine whether he or she has the sufficient credits to pay for the profile personalization. In particular embodiments, social networking system 20 displays a dialog box to the user prompting the user whether he agrees to the charges for profile personalization. Credits may be real currency; for example, profile personalization may cost 10 USD per month, and may be directly charged to the user's credit card account on file. In particular embodiments, credits are loosely tied to real-world currency, but have no value outside of social networking system 20. For example, social networking system may allow a user to purchase 4 credits for $4, 8 credits for $6, and 20 credits for $7 in order to encourage volume credit purchases. In particular embodiments, credits may be used as promotions in games, to purchase or sell virtual goods, or as winnings in gambling games. This disclosure contemplates any suitable manner of debiting a payment from a user account.

In particular embodiments, the pricing of profile customization to replace advertisement section 430 is priced to extract greater value to social networking system 20 than the traditional display of advertisements. For example, if a particular user receives, on average, 40 views per day, and the current bid for the display of an advertisement is $1/CPM (cost per 1000 impressions), any price over $0.04 per day results in greater revenue for social networking system 20. In particular embodiments, social networking system 20 adjusts the price of profile personalization based on a profit-maximization algorithm. This disclosure contemplates any suitable method of pricing profile personalization.

After determining the user account possesses sufficient credits and debiting the first payment, social networking system 20 displays the customized profile to the user, as well as any visitors to the user's page. In particular embodiments, the customized profile is subject to the privacy settings of the user. For example, if the identified social networking objects are only viewable by a specific set of users, customized profiles utilizing those objects are similarly limited to that specific group. In particular embodiments, the user may specify the privacy settings of his or her customized profile content. For example, because customized profiles are essentially advertisements or promotions for the user, a user wishing to paint himself or herself in the best possible light may wish for his or her personalized profile elements to be public to everyone. Thus, the user may manually adjust a privacy setting for his or her own personalized profile to “viewable by everyone.” Alternatively, social networking system 20 may automatically set personalized profile elements to “public.” This disclosure contemplates any manner of displaying the personalized profile to other users of social networking system 20.

At Step 505, after a predetermined amount of time after creation of the personalized profile, social networking system debits a recurring payment from the user account of the personalizing user. For example, the cost of personalizing a profile may be 10 credits/month. In particular embodiments, the subscription-based profile is cheaper for longer subscriptions, such as 10 credits/month or 80 credits/year. This disclosure contemplates any suitable time period for recurring billing for profile personalization.

If, at any billing period, the user account has insufficient credits to pay for profile personalization, the user's profile 400 reverts back to the standard profile, as displayed in FIGS. 4A and 4B, at Step 506. Thus, any advertisements on RHS 450 are again displayed to viewers viewing the user's profile 400 until payment is debited.

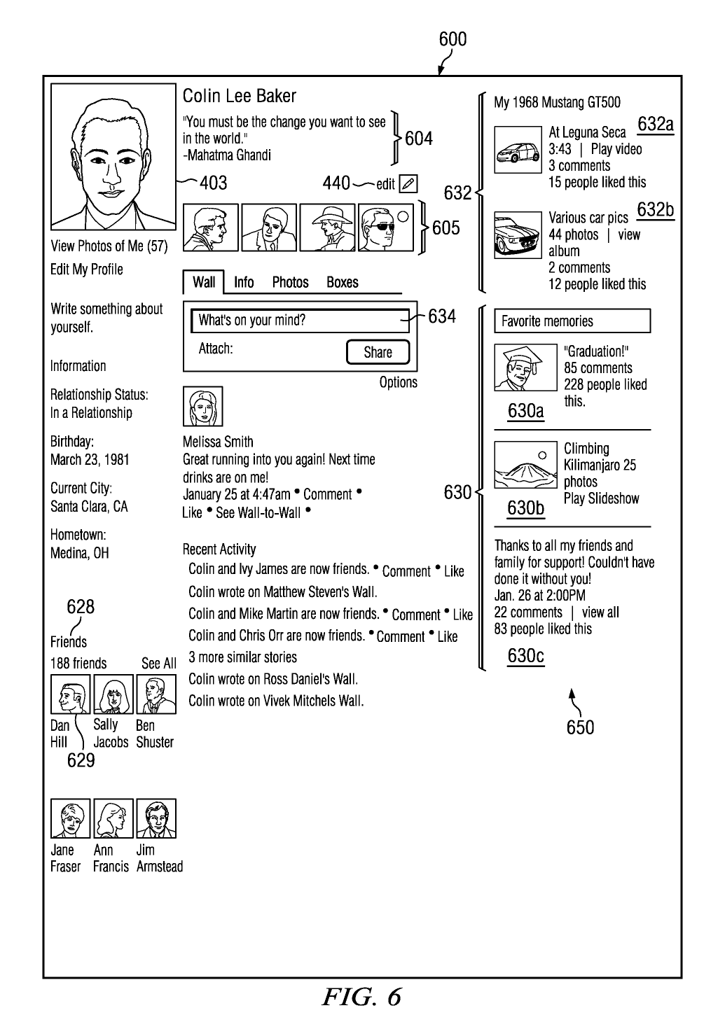

FIG. 6 depicts the display of a user viewing an example personalized profile 600. Personalized profile 600, in this example, contains personalized elements 604, 605, 632, and 630 that are typically controlled by social networking system 20. In this example, the user has replaced summary section 404 with a particular quotation 604. The user may identify the quotation from his or her own quotations section 420, or, in particular embodiments, may type in the quotation at the time of personalization. Profile 600 also includes personalized photo filmstrip 605; in this case the user has selected four photos of himself without a shirt as a means of self-promotion. In particular embodiments, the user may pay to have these photos periodically change or rotate through a particular album or set of photos.

In particular embodiments, the user may customize friends section 628 to adjust which friends are displayed. For example, the user may select his closest friends for display, or his most attractive female friends as a method of self-promotion. Personalized profile 600 also includes personalized content in RHS 650. Personalized content may be divided or segmented by the user, as in FIG. 6, or take up all of RHS 650 in a single block. In this example, the user has devoted a block 632 to photos and videos relating to his vehicle. In particular embodiments, the user may draw the boundaries of each section of RHS 650 and include free-form titles such as “My 1968 Mustang GT500”. In particular embodiments, social networking system 20 provides a graphical user interface for designing personalized RHS 650.

Personalized profile 600, in this particular example, includes a custom section 630 for “favorite memories”, which may be any social networking object. For example, the user has chosen to include a photo album 630a (“Graduation”), a photo slideshow 630b, and a particularly engaging status message 630c as a method of self-promotion. In particular embodiments, social networking system 20 prompts the user periodically if he or she would like to personalize his or her profile with highly engaged social networking objects. For example, after receiving a large number of comments or “likes” on a particular status message, the user may receive a dialog box prompting the user with the text: “Would you like to personalize your profile with this status message for 10 credits a month?” This disclosure contemplates any manner of promoting the profile personalization feature.

Thus, the aforementioned methods and systems provide paid profile personalization functionality that permits users to customize elements of their own profile pages that are otherwise controlled by social networking system 20. Permitting such functionality improves the overall user experience while maximizing revenue to the social networking system.

The applications or processes described herein can be implemented as a series of computer-readable instructions, embodied or encoded on or within a tangible data storage medium, that when executed are operable to cause one or more processors to implement the operations described above. While the foregoing processes and mechanisms can be implemented by a wide variety of physical systems and in a wide variety of network and computing environments, the computing systems described below provide example computing system architectures of the server and client systems described above, for didactic, rather than limiting, purposes.

FIG. 7 illustrates an example computing system architecture, which may be used to implement a server 22, 22b. In one embodiment, hardware system 700 comprises a processor 702, a cache memory 704, and one or more executable modules and drivers, stored on a tangible computer readable medium, directed to the functions described herein. Additionally, hardware system 700 includes a high performance input/output (I/O) bus 706 and a standard I/O bus 708. A host bridge 77 couples processor 702 to high performance I/O bus 706, whereas I/O bus bridge 712 couples the two buses 706 and 708 to each other. A system memory 714 and one or more network/communication interfaces 716 couple to bus 706. Hardware system 700 may further include video memory (not shown) and a display device coupled to the video memory. Mass storage 718, and I/O ports 720 couple to bus 708. Hardware system 700 may optionally include a keyboard and pointing device, and a display device (not shown) coupled to bus 708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 700 are described in greater detail below. In particular, network interface 716 provides communication between hardware system 700 and any of a wide range of networks, such as an Ethernet (e.g., IEEE 802.3) network, a backplane, etc. Mass storage 718 provides permanent storage for the data and programming instructions to perform the above-described functions implemented in the servers 22, 22b, whereas system memory 714 (e.g., DRAM) provides temporary storage for the data and programming instructions when executed by processor 702. I/O ports 620 are one or more serial and/or parallel communication ports that provide communication between additional peripheral devices, which may be coupled to hardware system 700.

Hardware system 700 may include a variety of system architectures; and various components of hardware system 700 may be rearranged. For example, cache 704 may be on-chip with processor 702. Alternatively, cache 704 and processor 702 may be packed together as a “processor module,” with processor 702 being referred to as the “processor core.” Furthermore, certain embodiments of the present invention may not require nor include all of the above components. For example, the peripheral devices shown coupled to standard I/O bus 708 may couple to high performance I/O bus 706. In addition, in some embodiments, only a single bus may exist, with the components of hardware system 700 being coupled to the single bus. Furthermore, hardware system 700 may include additional components, such as additional processors, storage devices, or memories.

In one implementation, the operations of the embodiments described herein are implemented as a series of executable modules run by hardware system 700, individually or collectively in a distributed computing environment. In a particular embodiment, a set of software modules and/or drivers implements a network communications protocol stack, browsing and other computing functions, optimization processes, and the like. The foregoing functional modules may be realized by hardware, executable modules stored on a computer readable medium, or a combination of both. For example, the functional modules may comprise a plurality or series of instructions to be executed by a processor in a hardware system, such as processor 702. Initially, the series of instructions may be stored on a storage device, such as mass storage 718. However, the series of instructions can be tangibly stored on any suitable storage medium, such as a diskette, CD-ROM, ROM, EEPROM, etc. Furthermore, the series of instructions need not be stored locally, and could be received from a remote storage device, such as a server on a network, via network/communications interface 716. The instructions are copied from the storage device, such as mass storage 718, into memory 714 and then accessed and executed by processor 702.

An operating system manages and controls the operation of hardware system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other implementations are possible. For example, the nickname generating functions described herein may be implemented in firmware or on an application specific integrated circuit.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. By way of example, while embodiments of the present invention have been described as operating in connection with a social networking website, the present invention can be used in connection with any communications facility that supports web applications. Furthermore, in some embodiments the term “web service” and “web-site” may be used interchangeably and additionally may refer to a custom or generalized API on a device, such as a mobile device (e.g., cellular phone, smart phone, personal GPS, personal digital assistance, personal gaming device, etc.), that makes API calls directly to a server.

What is claimed is:

1. A method comprising, by one or more computing systems:
receiving, from a user of a social networking system, a request to customize a layout of a profile page on the social networking system associated with the user;
debiting a predetermined amount from an account associated with the user;
arranging the profile in accordance with the request for display to members of the social networking system.

2. The method of claim 1, wherein the user's account is debited the predetermined amount on a recurring periodic basis.

3. The method of claim 1, wherein the request to customize a layout comprises a request to replace an ad space with one or more social networking objects.

4. The method of claim 3, wherein the one or more social networking objects comprises one or more photographs.

5. The method of claim 3, wherein the one or more social networking objects comprises one or more notes, status messages, or comments.

6. The method of claim 3, wherein the one or more social networking objects comprises one or more advertisements generated by the user.

7. The method of claim 3, wherein the one or more social networking objects comprises one or more videos.

8. A system comprising:
one or more processors;
one or more non-transitory, computer-readable media containing instructions operable to,
when executed by the one or more processors:
receive, from a user of a social networking system, a request to customize a layout of a profile page on the social networking system associated with the user;
debit a predetermined amount from an account associated with the user;
arrange the profile in accordance with the request for display to members of the social networking system.

9. The system of claim 8, wherein the user's account is debited the predetermined amount on a recurring periodic basis.

10. The system of claim 8, wherein the request to customize a layout comprises a request to replace an ad space with one or more social networking objects.

11. The system of claim 10, wherein the one or more social networking objects comprises one or more photographs.

12. The system of claim 10, wherein the one or more social networking objects comprises one or more notes, status messages, or comments.

13. The system of claim 10, wherein the one or more social networking objects comprises one or more advertisements generated by the user.

14. The system of claim 10, wherein the one or more social networking objects comprises one or more videos.

15. A system comprising:
means for receiving, from a user of a social networking system, a request to customize a layout of a profile page on the social networking system associated with the user;
means for debiting a predetermined amount from an account associated with the user;
means for arranging the profile in accordance with the request for display to members of the social networking system.

16. The system of claim 15, wherein the user's account is debited the predetermined amount on a recurring periodic basis.

17. The system of claim 15, wherein the request to customize a layout comprises a request to replace an ad space with one or more social networking objects.

18. The system of claim 17, wherein the one or more social networking objects comprises one or more photographs.

19. The system of claim 17, wherein the one or more social networking objects comprises one or more notes, status messages, or comments.

20. The system of claim 17, wherein the one or more social networking objects comprises one or more advertisements generated by the user.
